(19) United States
(12) Patent Application Publication
(10) Pub. No.: US 2007/0046786 A1
(43) Pub. Date: Mar. 1, 2007

(54) Filter correction circuit for camera system

(76) Inventor: Katsumi Tokuyama, Hyogo (JP)

Correspondence Address: MCDERMOTT WILL & EMERY LLP, 600 13TH STREET, N.W., WASHINGTON, DC, 20005-3096, US

(21) Appl. No.: 11/512,346

(22) Filed: Aug. 30, 2006

(30) Foreign Application Priority Data
Aug. 30, 2005 (JP) 2005-249077

(51) Int. Cl. H04N 5/228

(52) U.S. Cl. 348/222.1

(57) ABSTRACT

In a filter correction circuit for a camera system according to the present invention, a sample area information detector detects frequency band and fluctuation level of a video signal by a unit of sample area where a screen is divided into a plurality of areas. A filter area information detector detects the frequency band and fluctuation level of the video signal by a unit of filter area that is a subject of one-time filter processing in the single screen. A filter condition switching judgment device generates a selection control signal based on the result detected by the sample area information detector. A selector selects a filter coefficient to be applied based on the selection control signal. A filter processor fetches the filter coefficient selected by the selector, from a filter coefficient register, and applies it to the pixel unit or smallest pixel group unit that corresponds to the filter coefficient.

### BACKGROUND OF THE INVENTION

1. Field of the Invention

The present invention relates to a filter correction circuit used for video signal processing of a camera and the like to which signals of an image sensor are inputted.

2. Description of the Related Art

Conventionally, there have been cameras carrying a circuit for achieving autofocus function or like loaded thereon. Recently, application to be mounted on portable telephones and the like as a module has increased in such cameras, and therefore miniaturization and low-profile production have become an issue in such cameras module. However, size of the lens for an autofocus camera is large, which therefore is unfavorable for size reduction. Thus, it becomes important to use a single-focus lens and additionally correct blooming and blurring of the lens by signal processing for constituting the small-size camera module.

As a structure for correcting the blooming of the lens through the signal processing, it is common as shown in FIG. 17 to perform arithmetic processing of the video signals based on an inverse function of deterioration function (PSF) of the blooming of the lens. In the structure shown in FIG. 17, the inputted video signal turns to a deteriorated video signal through the arithmetic processing performed in a deterioration function process unit 71 according to the deterioration function. Noise n is added to the deteriorated signal in an adder unit 72, and it is then inputted to a correction unit 73. Signal processing is performed on the video signal by a noise elimination part 74 and inverse transform filter part 75 in the correction unit 73 to add the noise component. Specifically, in the correction unit 73, first, the noise is eliminated by the noise elimination part 74. Subsequently, the arithmetic processing is performed by the inverse transform filter part 75 based on the inverse function of the deterioration function, and the video signal is then outputted as a correction signal.

FIG. 18 shows the structure where this correction circuit is mounted to an actual camera system. All the light is inputted to an image sensor 7 through a lens 6. In an image with blooming, deterioration “i” due to the blooming is generated at the lens 6. The deteriorated signal is converted into an electric signal at the image sensor 7, which is then inputted to an analog processing circuit 8. At this time, in the image sensor 7, a signal line connecting the image sensor 7 and the analog processing circuit 8, and the analog processing circuit 8, propagation processing and signal-processing are performed as the analog signals in all of them. Thus, the electric signals (video signals) are likely to be influenced by the noise. Therefore, the signals become the video signals with the noises n1, n2, n3 added thereon, respectively. The video signals with the noise added thereon are A/D converted in the analog processing circuit 8 to be digital signals, which are then inputted to a digital signal processing circuit 9.

The digital signal processing circuit 9 consists of a noise elimination circuit 10, an inverse transform filter 11A, an YC processing circuit 12, and a memory cell 13. The digitalized video signals are inputted to the noise elimination circuit 10 where the noise thereof is eliminated. The video signals whose noise has been eliminated are inputted to the memory cell 13, and the area necessary for the filter constitution is stored as data.

Then, the video signals are outputted from the memory cell 13 to the inverse transform filter 11A. In the inverse transform filter 11A, the arithmetic processing is performed on the video signals based on the inversion function of the deterioration function to correct the deterioration (blooming). Then, the video signals whose deterioration has been corrected are stored in the memory cell 13. At this time, the video signals stored in the memory cell 13 are the signals whose blooming has been corrected. The video signals recorded in the memory cell 13 are signal-processed by the YC processing circuit 12, and the video signals after processing are outputted as the digital video signals. As shown in FIG. 19, the inverse transform filter correction plan designing part 11A has a simple filter structure, which is constituted only with filter coefficients having the function of the inverse transform as the coefficients.

This correction circuit is effective when the deterioration function of the blooming of the lens is determined. However, when there is a change in the deterioration function of the blooming, it is not possible to perform correction properly. Further, since different noise components are added in the image sensor and in the analog processing circuit under a state of analog signal, it becomes difficult to eliminate 100% of the noises by the noise elimination processing that is carried out in the latter stage. When the noise component remains in the video signals, it causes deterioration in the picture quality because the inverse transform filter accentuates the noise component.

As shown in pp. 2-3 of Japanese Patent Literature (Japanese Unexamined Patent Publication 60-249475) and FIG. 1, Fourier conversion is performed on the video signal, and a threshold value is set for the amplitude component of the converted signal so as to perform an inverse transform when it is higher than the threshold value, and not to perform when it is less than the threshold value. According to this, the issue of the accentuation on the noise component can be avoided. Furthermore, as shown in FIG. 3-FIG. 10 of US Patent Literature (U.S. Pat. No. 6,343,043), by performing correction with motion vector or the like, it is possible to deal with it even when there is a change in the deterioration function.

However, these related arts are effective for the case where there is less noise for a specific blooming. In contrast, when the blooming has changed or the S/N ratio at the time of low luminance or the like is bad, inversely, it is probable to deteriorate the picture quality.

### SUMMARY OF THE INVENTION

The main object of the present invention therefore is to increase the accuracy to follow the fluctuations of the blooming. Further, it is to improve the S/N ratio of the video signal at the time of low luminance or the like where the deterioration of the S/N ratio is concerned more than the resolution.

A filter correction circuit for a camera system according to the present invention comprises:
a sample area information detector for detecting frequency band and fluctuation level of a video signal by a unit of sample area where a single screen is sectioned into a plurality of areas;
a filter area information detector for detecting the frequency band and fluctuation level of the video signal by a unit of filter area that becomes a target of one-time filter processing in the single screen;
a filter condition switching judgment device wherein it judges which of filter conditions each sample area corresponds to based on a result detected by the sample area information detector and at the same time judges a filter type to be applied to a pixel unit or a smallest pixel group unit based on a result detected by the filter area information detector, sp as to generate a selection control signal indicating a filter coefficient that corresponds to the filter condition and the filter type which have been judged;
a filter coefficient register to which a plurality of kinds of filter coefficients having different properties from each other are stored;
a selector for selecting a filter coefficient to be applied from the plurality of kinds of filter coefficients in the filter coefficient register based on the selection control signal generated by the filter condition switching judgment device; and
a filter processor which fetches the filter coefficient selected by the selector from the filter coefficient register and applies it to the pixel unit or smallest pixel group unit which corresponds to the filter coefficient.

There are the following preferable embodiments in the above description. The sample area is set in a size with which subject image features on a single screen can be separated. Further, the sample area is set larger than the filter area.

Furthermore, it is desirable that the filter coefficient register store a plurality of kinds of inversion filter coefficients having different properties from each other as the plurality of kinds of filter coefficients, and the filter condition switching judgment device judge which of the plurality of kinds of inverse transform filter coefficients is applied based on the frequency band detected by the sample area information detector and the frequency band detected by the filter area information detector. As the plurality of kinds of inverse transform filter coefficients, for example, there are three pixel-three line inverse transform filter coefficient and five pixel-five line inversion inverse transform coefficient.

Further, it is desirable that the filter coefficient register store an inverse transform filter coefficient and a mean value filter coefficient as the plurality of kinds of filter coefficient, and the filter condition switching judgment device judge which of the inverse transform filter coefficient or the mean value filter coefficient is applied based on the fluctuation level detected by the sample area information detector and the fluctuation level detected by the filter area information detector.

Furthermore, it is desirable that the filter coefficient register store, as the plurality of kinds of filter coefficients, the inverse transform filter coefficient, the mean value filter coefficient, and a lowpass filter coefficient, and the filter condition switching judgment device apply the lowpass filter coefficient to a boundary at which application of the inverse transform filter coefficient is switched to application of the mean value filter coefficient, or to a boundary at which application of the mean value filter coefficient is switched to the inverse transform filter coefficient. By doing so, a smooth image can be achieved by applying the lowpass filter to the boundaries.

Furthermore, it is desirable that the filter coefficient register contains, the inverse transform filter coefficient and a plurality of kinds of filter coefficients having different properties from each other as the plurality of kinds of filter coefficients, and the filter condition switching judgment device judge which of the plurality of kinds of mean value filter coefficients to apply in accordance with size of an area considered as having a small fluctuation level that is detected by the sample area information detector, in applying the mean value filter coefficient. Thereby, the filter coefficient in accordance with the size of the corresponding area is selected.

As described above, in the present invention, the inverse transform filter coefficient is applied to the high frequency video area, and the mean value filter coefficient is applied to the video area with DC-component. Further, according to need, the lowpass filter coefficient is applied with respect to the boundaries between both areas to smoothen the image. A fine image can be obtained by correcting the blooming of the image while improving the following accuracy for the fluctuation of the blooming. At the same time, it is possible to improve the S/N ratio of the video signal at the time of low luminance where the deterioration in the S/N ratio is concerned more than the resolution.

Further, it is desirable that the sample area information detector further detect color information of the sample area, the filter area information detector further detect color information of the filter area, and the filter condition switching judgment device determine which of the inverse transform filter coefficient or the mean value filter coefficient is applied in accordance with at least either the color information of the sample area detected by the sample area information detector or positional information of the sample area, and the color information of the filter area detected by the filter information detector. The reason is as follows.

In general, the video signal has following characteristics.
it is possible to have a noise superimposed thereupon if the level of a component is low even when there is a high frequency component
plants, trees, and grasses exhibit their characteristics in the color signals so as to provide a large green component
a sandbox and asphalt are normally close to one's feet, so that it is highly probable that they are at the bottom of the image
the color close to green tends to be seized with the inverse transform filter, and other colors tend to be seized with the mean value filter

By adding the above-described improvements to the present invention, it becomes possible to select the optimum filter coefficient for the video signals having such characteristics.

Furthermore, it is desirable that the sample area information detector further detect luminance level and color level of the sample area, the filter area information detector further detect luminance level and color level of the filter area, and the filter condition switching judgment device change correction level by changing a center coefficient of the filter coefficients based on at least either the luminance level or the color level detected by at least either the sample area information detector or the filter area information detector. By doing so, the ratio of the target pixel to the peripheral pixels becomes increased so as to thereby decrease the degree of filter processing by increasing the center coefficient value. Inversely, by decreasing the center coefficient value, the degree of the filter processing becomes larger.

Further, in Bayer array before performing YC processing, it is desirable to perform correction in real time through carrying out filter processing with the filter processor by a unit of R, G, and B.

Furthermore, it is desirable to perform filter processing with the filter processor to Y, Cr, Cb after YC-processing, so as to change filter switching condition in accordance with an image.

Moreover, it is preferable to further comprise a CPU for controlling the filter correction circuit, wherein
filter switching accuracy is increased by fetching information detected by the sample area information detector into the CPU.

Further, in the above-described structure, it is preferable to further comprise other wave-detector, wherein
the sample area information detector is used together with the other wave-detector.

In a small-size camera system, it is possible according to the present invention to correct the blooming of an image to obtain a fine picture and, at the same time, to achieve improvements in the S/N ratio of the video signals at the time of low luminance where the deterioration of the S/N ratio is concerned more than the resolution.

Further, by using it as the filter in the latter stage after the YC processing, it becomes possible to improve the correction accuracy through customizing the filter coefficient, which is effective as the structure for correcting the recorded video signals.

The technique of the filter correction circuit in a camera system according to the present invention is effective as the structure for processing the video signals of a camera and the like, in which optical information inputted through a lens is converted into electric signals by an image sensor.

### BRIEF DESCRIPTION OF THE DRAWINGS

Other objects of the present invention will become clear from the following description of the preferred embodiments and the appended claims. Those skilled in the art will appreciate that there are many other advantages of the present invention by putting the present invention into practice.

FIG. 1 is an conceptual diagram for explanation of a filter correction circuit in a camera system according to an embodiment of the present invention;

FIG. 2 is a block diagram for showing the structure of a camera system to which the filter correction circuit according to the embodiment of the present invention is applied;

FIG. 3 is a block diagram for showing the structure of an adaptive filter correction circuit according to the embodiment of the present invention;

FIG. 4 is an exemplification diagram of mean value filter coefficients, lowpass filter coefficients, and inverse transform filter coefficients of five pixels in five lines according toe the embodiment of the present invention;

FIG. 5 is an illustration for sample areas in the embodiment of the present invention;

FIG. 6 is an illustration for filter areas in the embodiment of the present invention;

FIG. 7 is a schematic diagram for showing the filter condition switching control according to the embodiment of the present invention;

FIG. 8 is a block diagram for showing the structure of a sample area information detector according to the embodiment of the present invention;

FIG. 9 is a block diagram for showing the structure of a filter area information detector according to the embodiment of the present invention;

FIG. 10 is a flowchart for showing operation of judging the sample area condition according to the embodiment of the present invention;

FIG. 11 is a diagram of the sample area for explanation of the specific action;

FIG. 12 is a flowchart for showing operation of judging the filter area condition according to the embodiment of the present invention;

FIG. 13 is a flowchart for showing action of filter condition switching control according to the embodiment of the present invention;

FIG. 14 is a flowchart for showing another action of filter condition switching control according to the embodiment of the present invention;

FIG. 15 is a block diagram for showing the structure of an adaptive filter correction circuit according to an embodiment of the present invention;

FIG. 16 is a block diagram for showing another form of the camera system according to the present invention;

FIG. 17 is an conceptual illustration of a filter correction circuit for a camera system according to a related art;

FIG. 18 is a block diagram for showing the structure of a camera system to which the filter correction circuit of the related art is applied; and

FIG. 19 is an illustration for the filter structure of the related art.

### DETAILED DESCRIPTION OF THE INVENTION

Hereinafter, preferred embodiments of a filter correction circuit for a camera system according to the present invention will be described in detail referring to the accompanying drawings.

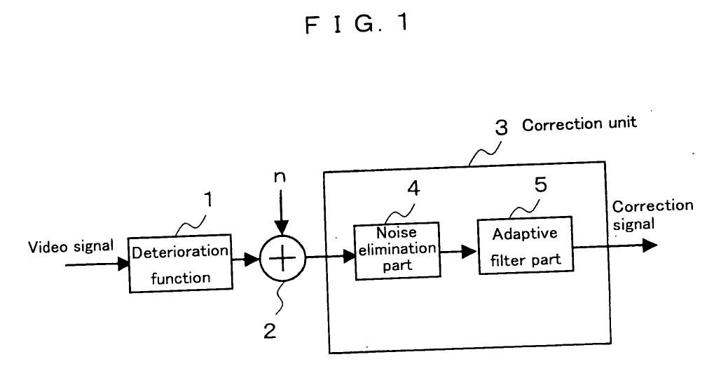

FIG. 1 is an conceptual illustration of the filter correction circuit for a camera system according to an embodiment of the present invention. An inputted video signal receives arithmetic processing in a deterioration function process unit 1 based on a deterioration function, and therefore it becomes a deteriorated video signal. Further, the deteriorated video signal is processed in an adder unit 2 where it becomes a video signal with noise n added thereon, which is then inputted to a correction unit 3. The correction unit 3 consists of a noise elimination part 4 and an adaptive filter part 5. The video signal inputted to the correction unit 3 is in a form of the signal that is the deteriorated video signal with a noise component added thereto. Thus, in the correction unit 3, first, the noise is eliminated at the noise elimination part 4, thereafter, the frequency component and the fluctuation level are detected, and inverse function filter processing, averaging filter processing, and lowpass filter processing may be carried out appropriately to perform correction. Then, the corrected video signal is outputted as the correction signal. In the present invention, this adaptive filter 5 is the direct target of the technical improvement.

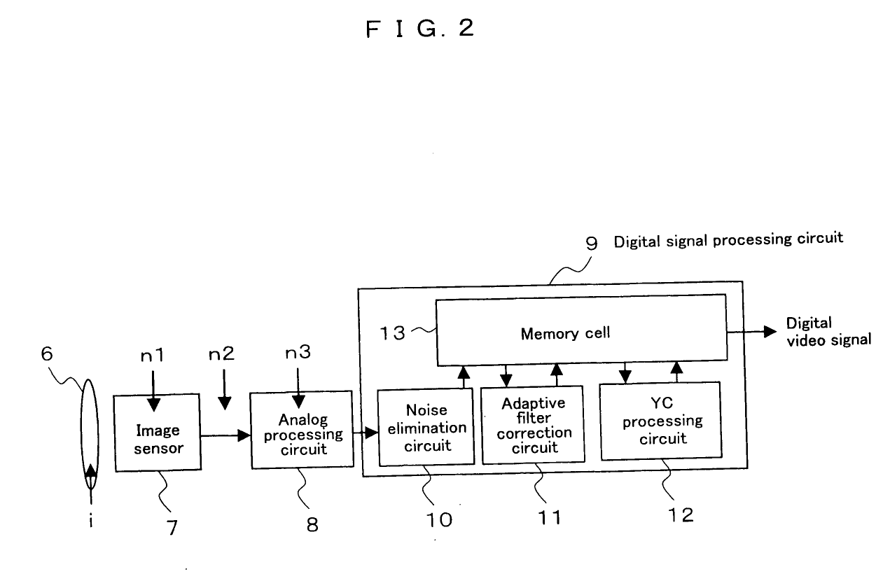

FIG. 2 shows the state where this correction circuit is mounted to an actual camera system. All the light is inputted to an image sensor through a lens 6. In an image with blooming, deterioration “i” due to the blooming is generated at the lens 6. A deteriorated signal is converted into an electric signal at the image sensor 7, which is then inputted to an analog processing circuit 8. At this time, the image sensor 7, a signal line from the image sensor 7 to the analog processing circuit 8, and the analog processing circuit 8 are all targeted to the analog signal, so that it is under a state where they are likely to be influenced by the noise. The video signals in the analog processing circuit 8 have noise n1, noise n2, and noise n3, added thereon. The video signals with the added noise are A/D converted in the analog processing circuit 8 to be digital signals and inputted to a digital signal processing circuit 9. The digital signal processing circuit 9 consists of a noise elimination circuit 10, an adaptive filter correction circuit 11, an YC processing circuit 12, and a memory cell 13.

The digitalized video signals are inputted to the noise elimination circuit 10 in order to eliminate the noise. The video signals whose noise has been eliminated are inputted to the memory cell 13, and the areas necessary for the filter structure is stored as a data. Then, the video signals are outputted to the adaptive filter correction circuit 11 and corrected therein (processing for picture quality deterioration such as blooming). The corrected video signals are sent back again to the memory cell 13 and stored therein. At this time, the video signals stored in the memory cell 13 have been the signals after the correction processing (processing for blooming) has been performed. The video signals are outputted from the memory cell 13 and signal-processed at the YC processing circuit 12, which are then outputted as the digital video signals.

At this time, the content of the processing by the adaptive filter correction circuit 11 is different form that of the related art. The adaptive filter correction circuit 11 is the direct target of the technical improvement in the present invention. The adaptive filter correction circuit 11 will be described hereinafter.

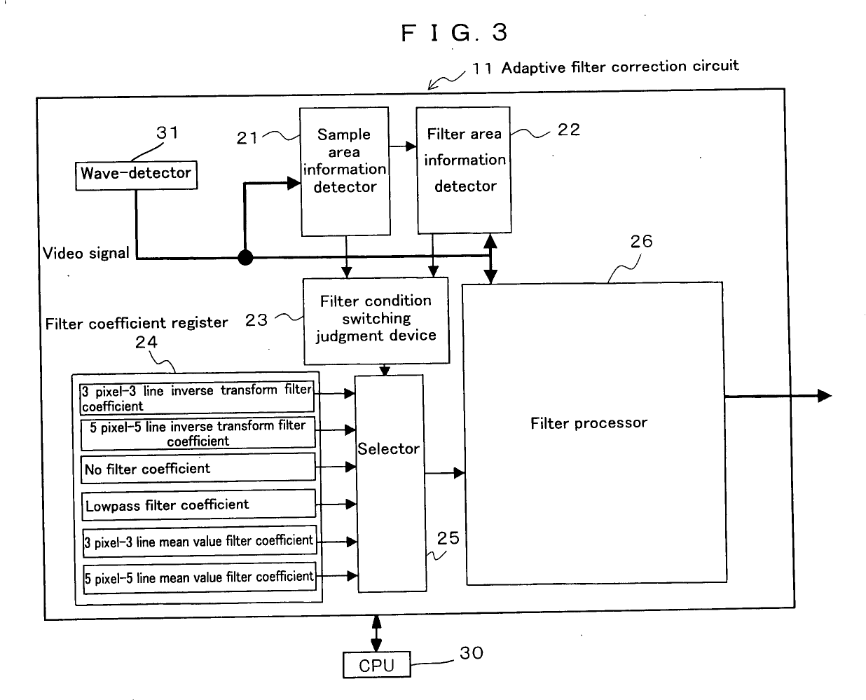

FIG. 3 is a block diagram for showing the structure of the adaptive filter correction circuit 11 according to the embodiment. The adaptive filter correction circuit 11 comprises a sample area information detector 21, a filter area information detector 22, a filter condition switching judgment device 23, a filter coefficient register 24, a selector 25, a filter processor 26, a CPU 30, and other wave-detector circuit 31.

The sample area information detector 21 detects the frequency band and fluctuation level of the video signal and the like by a unit of each sample area that is one of a plurality of sections separated from a single screen. The filter area information detector 22 detects the frequency band and fluctuation level of the video signal and the like by a unit of each filter area that is one of a plurality of sections of a single screen. The filter condition switching judgment device 23 judges which filter condition each sample area corresponds to, based on the information detected by the sample area information detector 21, and generates a selection control signal by determining the filter type to be applied by a pixel unit or small-number pixel group unit, based on the information detected by the filter area information detector 22.

The filter coefficient register 24 comprises a plurality of kinds of filter coefficients having different properties from each other. The selector 25 selects the filter coefficient to be applied from the plurality of kinds of filter coefficients in the filter coefficient register 24, based on the selection control signal of the filter condition switching judgment device 23. The filter processor 26 performs the filter processing operation.

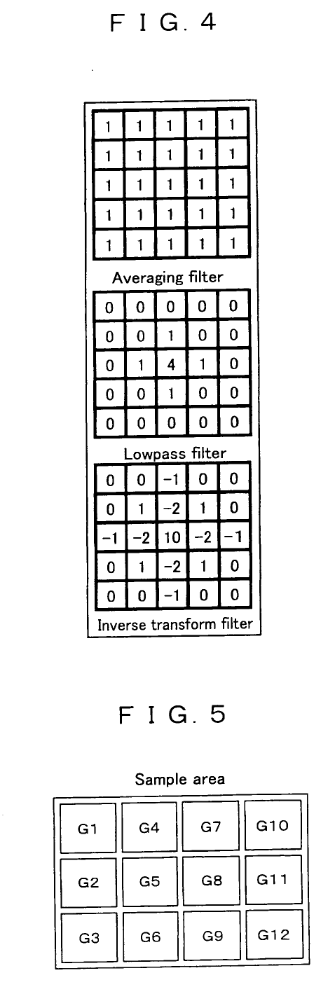

The filter coefficient register 24 comprises: inverse transform filter coefficients of three pixels in three lines; inverse transform filter coefficients of five pixels in five lines; no filter coefficients; lowpass filter coefficients; mean value filter coefficients of three pixels in three lines; and mean value filter coefficients of five pixels in five lines. FIG. 4 shows an example of the mean value filter coefficients, the lowpass filter coefficients, and the inverse transform filter coefficients.

The sample area information detector 21 performs, calculations of frequency component, fluctuation level, luminance level, and color signal level to the video signals. The sample area, as shown in FIG. 5, indicates each area separated from a single screen, and the processing is performed on all of the sample areas by each area. The sample area is set in a size where the subject video features on a single screen can be separated. In FIG. 5, a single screen is divided into twelve areas of G1-G12. The sample area information detector 21 performs calculations of frequency component, fluctuation level, luminance level, and color signal level by each of the sample areas G1-G12. The results of calculations are outputted from the sample area information detector 21 to the filter condition switching judgment device 23.

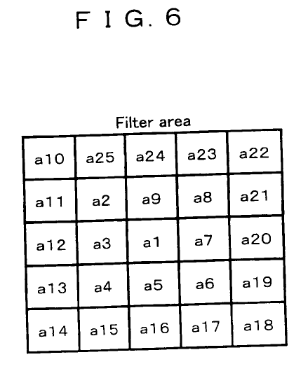

The filter area information detector 22 performs calculations of frequency component, fluctuation level, luminance level, and color signal level to the video signals. The filter area as the target of the calculation at this time is the area of n×n (pixels) that actually forms the filter. Here, the case of the area of 5×5 (pixels), as shown in FIG. 6, will be described as an example. The calculation results of the frequency component, the fluctuation level, the luminance level, and the color signal level, which are detected by the filter area information detector 22, are outputted from the filter area information detector 22 to the filter condition switching judgment device 23.

The filter condition switching judgment device 23 determines the filter type to be applied by the unit of pixel in accordance with the results of the calculations in the sample area information detector 21 and the results of the calculations in the filter area information detector 22, generates the selection control signal based on the determined filter type, and controls the selector 25 by the unit of pixel based on the selection control signal.

The selector 25 selects the proper filter coefficient from the filter coefficient register 24 based on the selection control signal, and outputs it to the filter processor 26. The filter processor 26 performs processing by each pixel while setting the filter coefficient inputted from the selector 25 as the proper filter coefficient for the respective pixel, and outputs the processed data.

The CPU 30 controls the entire circuit including the filter correction circuit. The other wave-detector circuit 31 detects the video signals for generating autofocus control signals.

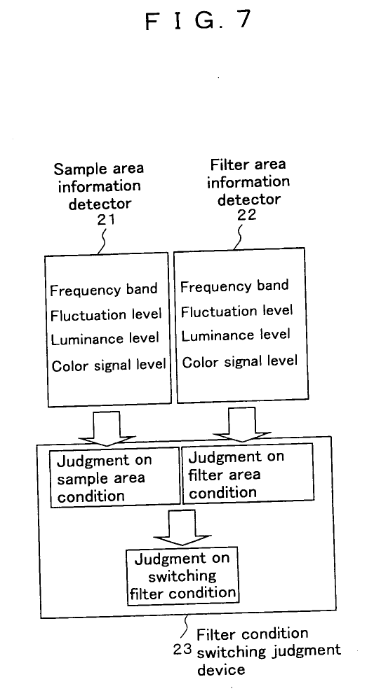

In the above-described structure, the sample area information detector 21, the filter area information detector 22, and the filter condition switching judgment device 23 carry out the switching control of the filter coefficients. FIG. 7 shows the flow of the filter switching control. In the description provided below, the numbers (1st, - - - ) applied to each frame indicates that the larger the number becomes, the more it drops back in terms of time.

First, in the 1st frame, the video signal is inputted to the sample area information detector 21. The sample area information detector 21 calculates the fluctuation level of Nyquist frequency band, the numbers of times of fluctuation in the high frequency band, the mean value of the luminance level, and the mean value of the color signal level, and outputs the results to the filter condition switching judgment device 23. The filter condition switching judgment device 23 performs judgment on the sample area condition based on the calculation results of the mean values.

Then, in the 2nd frame, the same video signal as that of the 1st frame is inputted to the filter area information detector 22, while the video signal of the next frame (2nd frame) is inputted to the sample area information detector 21. Like this, the sample area information detector 21 always performs processing on the video signal that is one frame earlier than that of the filter area information detector 22. The filter area information detector 22 calculates the 3×3 peripheral pixel differential data, 5×5 peripheral pixel differential data, the mean value of the luminance level, and the mean value of the color signal level. The calculation results are outputted from the filter area information detector 22 to the filter condition switching judgment device 23. The filter condition switching judgment device 23 performs judgment on the filter area condition based on the calculation results of the filter area information detector 22. Specifically, the filter condition switching judgment device 23 performs the judgment on switching the filter conditions based on the sample area condition judgment result of the frame just before the current frame and the filter area condition judgment result of the current frame for controlling the filter coefficient.

At this time, high-speed action by a unit of pixel is required in the filter area information detector 22 in order to consider the switching processing for each pixel. However, for the detection of the sample frame, it is fine that the results of all the sample area can be calculated within one frame. Thus, high-speed processing is not required in the sample area information detector 21. Considering this, transferring the detection results to the CPU 30 for carrying out the arithmetic processing therein may be effective in order to increase the accuracy of switching conditions, because it becomes easier by transferring them to the CPU 30 to achieve correction of the conditions within the area, or correction of the boundaries between the adjacent areas and the like based on the correlations between each sample area. Further, in the structure with the wave-detector circuit 31 with an autofocus, the detection results of the wave-detector circuit 31 can be substituted as the sample area detection result.

The description will be given here to the case of the structure that uses the sample area information detector 21 exclusively as a hard circuit. In the followings, the details of the filter switching control will be described.

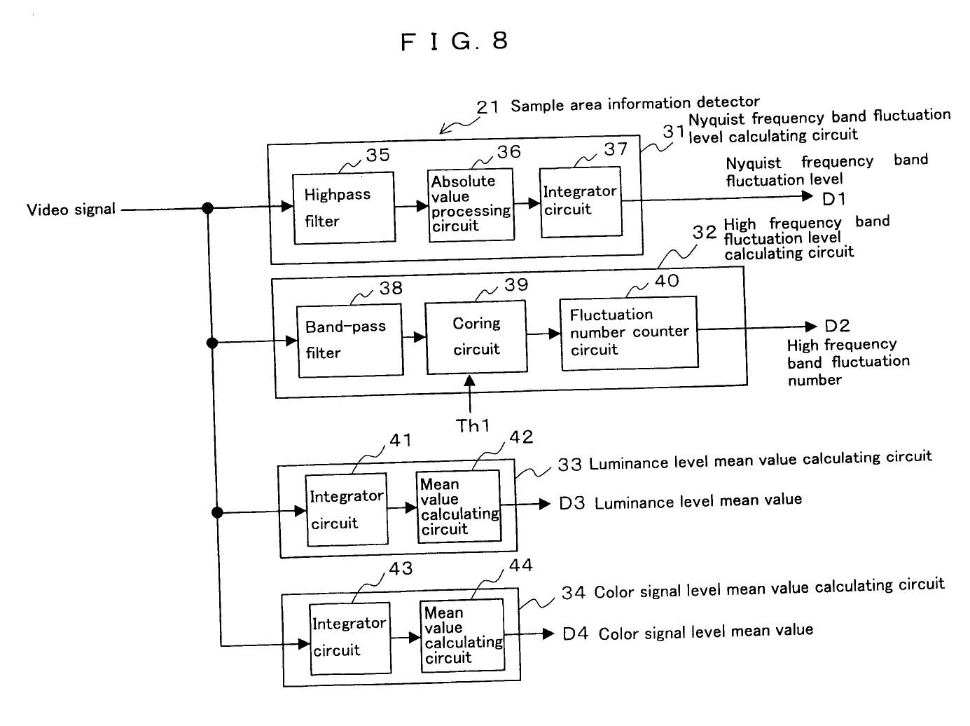

FIG. 8 is a block diagram for showing the structure of the sample area information detector 21. The sample area information detector 21 comprises a Nyquist frequency band fluctuation level calculating circuit 31, a high frequency band fluctuation level calculating circuit 32, a luminance level mean value calculating circuit 33, and a color signal level mean value calculating circuit 34. The Nyquist frequency band fluctuation level calculating circuit 31 comprises a highpass filter 35 that lets through the Nyquist frequency component, an absolute value processing circuit 36, and an integrator circuit 37. The video signal is inputted to the highpass filter 35 where only the Nyquist frequency component is extracted form the video signal. The extracted Nyquist frequency component receives absolute value processing in the absolute value processing circuit 36. The integrator circuit 37 integrates the Nyquist frequency component processed into an absolute value. The Nyquist frequency component with the absolute value, which has been integrated in the integrator circuit 37, indicates the fluctuation level of the Nyquist frequency band within the sample area, and the signal is outputted from the integrator circuit 37 as the Nyquist frequency band fluctuation level D1.

The high frequency band fluctuation level calculating circuit 32 comprises a band-pass filter 38 that lets through the high frequency band, a coring circuit 39, and a fluctuation number counter circuit 40. Threshold value Th1 for controlling the coring value is inputted to the coring circuit 39.

The video signal is inputted to the band-pass filter 38, and only the high frequency component is extracted at the band-pass filter 38. The extracted high frequency component signal is clipped in 0-level less than the threshold value Th1 by the coring circuit 39. The high frequency component contains a noise component. Therefore, for eliminating the noise, the threshold value Th1 is set as the noise level so as to suppress the fluctuation of the noise level to 0-level.

The high frequency component signal to which coring processing is carried out is inputted to the fluctuation number counter circuit 40. The fluctuation number counter circuit 40 detects the change points of the coring-processed high frequency component signal for counting the changed number (the number of changed points). The number counted by the fluctuation number counter circuit 40 herein indicates how many high frequency components of more than the noise level there are within the area. This count number is outputted as the high frequency band fluctuation number D2.

The luminance level mean value calculating circuit 33 comprises an integrator circuit 41 and a mean value calculating circuit 42. The luminance signals of the video signals are integrated at the integrator circuit 41. The integrated luminance signals are inputted to the mean value integrator circuit 42 where the mean value of the luminance levels per pixel is calculated. The calculated mean value of the luminance levels is outputted as the luminance level mean value D3 from the mean value calculating circuit 42.

The color signal level mean value calculating circuit 34 comprises an integrator circuit 43 and a mean value calculating circuit 44. The color signals of the video signals are integrated at the integrator circuit 43. The integrated color signals are inputted to the mean value integrator circuit 44 where the mean value of the color signal levels per pixel is calculated. The calculated mean value of the color signals is outputted as the color signal level mean value D4 from the mean value calculating circuit 44.

The Nyquist frequency band fluctuation level D1, the high frequency band fluctuation number D2, the luminance level mean value D3, and the color signal level mean value D4 calculated in the manner described above are inputted to the filter condition switching judgment device 23.

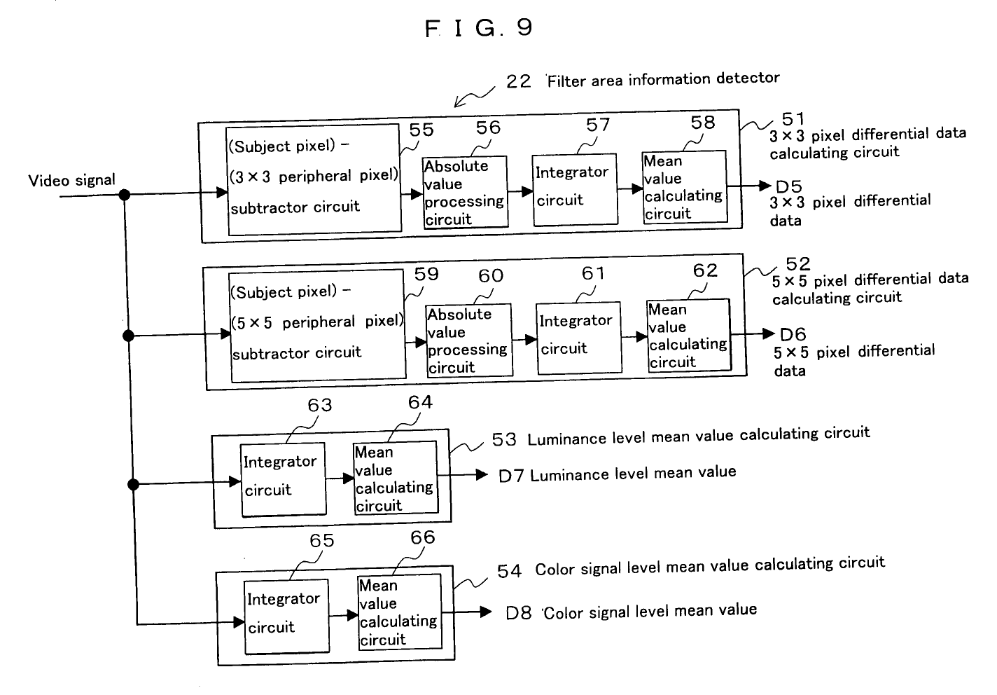

FIG. 9 is a block diagram for showing the structure of the filter area information detector 22. FIG. 6 shows a detection area (filter area) of the filter area information detector 22. The noteworthy pixel as the target of the processing within the filter area is pixel “a1” in the center. The filter area information detector 22 comprises a 3×3 peripheral pixel differential data calculating circuit 51, a 5×5 peripheral pixel differential data calculating circuit 52, a luminance level mean value calculating circuit 53, and a color signal level mean value calculating circuit 54.

The 3×3 peripheral pixel differential data calculating circuit 51 comprises a subtractor circuit 55, an absolute value processing circuit 56, an integrator circuit 57 and a mean value calculating circuit 58. The video signal is inputted to the subtractor circuit 55. The subtractor circuit 55 calculates the difference between the target pixel “a1” and the pixels “a2”-“a9” that are adjacent to the noteworthy pixel “a1”. Eight differential values are calculated in accordance with the number of adjacent pixels a2-a9. These differential values are processed to absolute values, respectively by the absolute value processing circuit 56. Then, these differential values are added in the integrator circuit 57, which are further processed into a mean value (one eighth processing) by the mean value calculating circuit 58 to calculate the differential mean value per pixel. The calculated differential mean value is the mean value of the differences between the noteworthy pixel “a1” and the adjacent pixels “a2”-“a9”. The magnitude of this differential mean value shows the size of the change in the high frequency component, i.e. the change in the 3×3 pixels herein. The operation result (differential mean value) is outputted as the 3×3 pixel differential data D5 from the mean value calculating circuit 58.

The 5×5 peripheral pixel differential data calculating circuit 52 comprises a subtractor circuit 59, an absolute value processing circuit 60, an integrator circuit 61 and a mean value calculating circuit 62. The video signal is inputted to the subtractor circuit 59. The subtarctor circuit 59 calculates the differences between the target pixel “a1” and the pixels “a10”-“a25” that are further adjacent to the pixels “a2”-“a9”. Sixteen differential values are calculated in accordance with the number of adjacent pixels “a10”-“a25”. These differential values are processed to absolute values, respectively by the absolute value processing circuit 60. Then, these differential values are added in the integrator circuit 61, which are further processed into a mean value (one sixteenth processing) by the mean value calculating circuit 62 to calculate the differential mean value per pixel. The calculated differential mean value is the mean value of the differences between the noteworthy pixel and the adjacent pixels that are the two pixels ahead from the noteworthy pixel. The magnitude of this differential mean value shows the size of the change in the high frequency component, i.e. the change in the 5×5 pixels herein. The operation result (differential mean value) is outputted as the 5×5 pixel differential data D6 from the mean value calculating circuit 62.

The luminance level mean value calculating circuit 53 comprises an integrator circuit 63 and a mean value calculating circuit 64. The integrator circuit 63 integrates the luminance signals of the video signals. The integrated luminance signals are processed into mean value in the mean value integrator circuit 64 where the mean value of the luminance levels per pixel is calculated. The calculated luminance level mean value D7 is outputted from the mean value calculating circuit 64.

The color signal level mean value calculating circuit 54 comprises an integrator circuit 65 and a mean value calculating circuit 66. The integrator circuit 65 integrates the color signals of the video signals. The integrated color signals are processed into mean value in the mean value integrator circuit 66 where the mean value of the color signal levels per pixel is calculated. The calculated color signal mean value D8 is outputted from the mean value calculating circuit 66.

The 3×3 pixel differential data D5, the 5×5 pixel differential data D6, the luminance level mean value D7, and the color signal level mean value D8 calculated in the manner mentioned above are inputted to the filter condition switching judgment device 23.

The filter condition switching judgment device 23 carries out judgments on sample area condition and filter area condition based on the data inputted from the sample area information detector 21 and the data inputted from the filter area information detector 22.

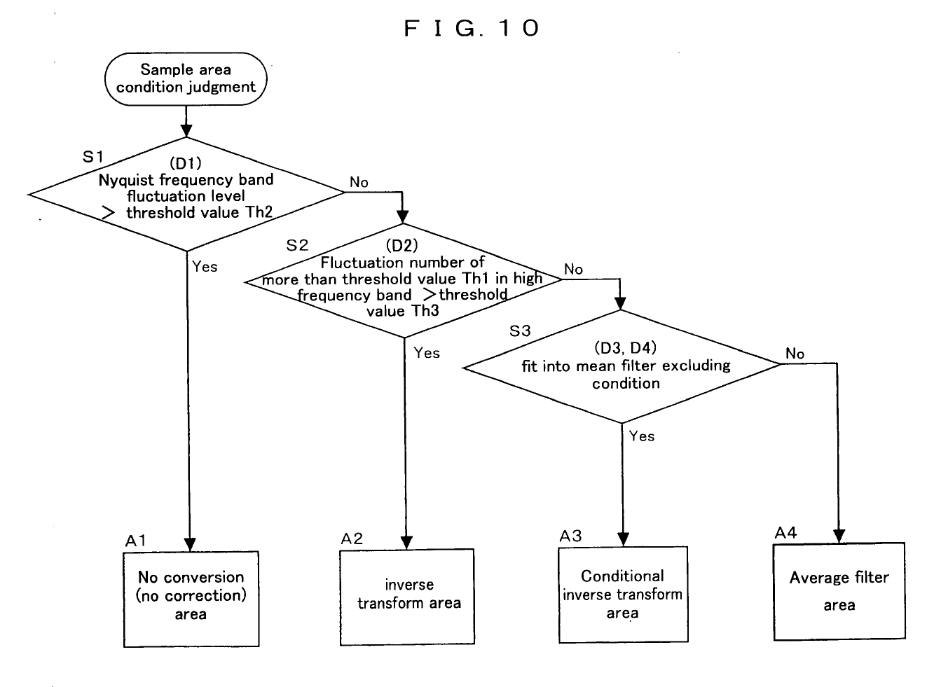

FIG. 10 shows a flowchart of judgment on the sample area condition performed in the filter condition switching judgment device 23. The filter condition switching judgment device 23 judges which of the following areas the sample area is adapted to, based on the inputted conditions described above,
no conversion area “A1” with sufficient resolution which does not require any correction of blooming
an inverse transform area “A2” where it is important to correct the blooming
a conditional inverse transform area “A3” which requires correction of blooming under a certain condition
an average filter area A4 with almost no frequency fluctuation where it is important to cancel the noise

First, it is judged whether or not condition S1, “the Nyquist frequency band fluctuation level>threshold value Th2”, is satisfied. As the frequency bands concentrate when the lens is in focus, the change of the pixel unit indicates a large magnitude. Thus, when the Nyquist frequency component is large, it means that there is no blooming generated. Therefore, when the condition S1 is satisfied, it is unnecessary to perform the inverse transform filter processing. Based on this, when the condition S1 is satisfied, the sample area is judged as adapted to the no conversion area A1.

When the condition S1 is not satisfied, it is judged whether or not condition S2, “the fluctuation number of more than the threshold value Th1 in the high frequency band>threshold value Th3”, is satisfied. The video with the high frequency component is a part where there is a large change amount in the subject, which means that it is not a wall, sky or the like but some kind of complicated figured subject.

When the conditions S1 is not satisfied and it is shifted to the condition S2, it is assumed as either one of the followings.
blooming is generated
it is a subject with no high frequency component in the actual image

Thus, in order to judge whether or not the high frequency component is present, it is judged whether or not the condition S2, “the fluctuation number of more than the threshold value Th1 in the high frequency band>threshold value Th3”, is satisfied. When the condition S2 is satisfied, it is judged that the video in the sample area contains the high frequency component and it is highly probable that the video has blooming. Based on this judgment, this sample area is judged as being adaptable to the inverse transform area A2 where correction of the blooming is considered important.

When the condition S2 is not satisfied, it is judged whether or not condition S3, “that fits or not to the average filter excluding condition”, is satisfied. When the condition S2 is not satisfied and it is shifted to judgment of the condition S3, it is assumed as either one of the followings.
no high frequency component is present
the level is low

As it is highly possible that the high frequency component with low level contains a noise, it is not preferable to perform inverse transform processing. However, there also exists the low-level high frequency component when the green plants, trees, and grasses are the subjects or when the sandbox, asphalt or the like is the subject. For such subjects, it is rather preferable to perform the inverse transform processing to accentuate the high frequency component than performing the average filter processing. Such condition is set as the average filter excluding condition S3. For example, in the case of the green plants, trees and grasses, there is a large apparent feature in the color signal so as to provide the large green component. Therefore, upper-limit and lower-limit threshold values are set for the color signals as the excluding condition. Furthermore, the upper-limit and lower-limit threshold values are set for the color signals also for the sand box and asphalt, and the alignment information of the areas is added to the condition as well for preventing misjudgments. Normally, as the sandbox and asphalt are on one's feet, it exists only in the lower part of the image. Therefore, it becomes the condition to belong to only the sample areas of G3, G6, G9, and G12 in the sample areas shown in FIG. 5. The sample area having mainly the green plants and trees as the subjects, which satisfies the average filter excluding condition S3, is judged as the conditional inversion area A3.

The sample area that does not satisfy the average filter excluding condition S3 is judged as the average filter area A4 where there is almost no high frequency component. In the sample area judged as the average filter area A4, it is possible to obtain a fine image through reducing the noise by the averaging processing rather than increasing the resolution by the inverse transform.

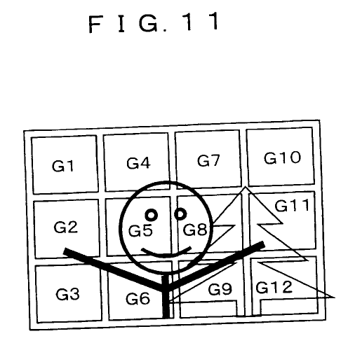

For example, as shown in FIG. 11, the following images are considered.
the background is a white wall
there is a green tree in front of the white wall
there is a person further in front thereof
blooming is generated

In this image, the sample areas G1, G2, G3, G4, G7, and G10 are the areas with no high frequency component, which satisfy none of the conditions S1, S2 or S3. Thus, these sample areas are judged as the average filter areas A4. There causes a large difference in the levels of the color signals in the sample areas G11 and G12 containing the green tree and the green component in the part where there is the green tree becomes large. Thus, the condition S3 is satisfied, although the conditions S1 and S2 are not. Therefore, these sample areas are judged as the conditional inverse transform area A3. There is the high frequency component in the sample areas G5, G6, G8 and G9 including the person(s). Thus, condition S2 is satisfied, although the condition S1 is not. Therefore, these are judged as the inverse transform areas A2.

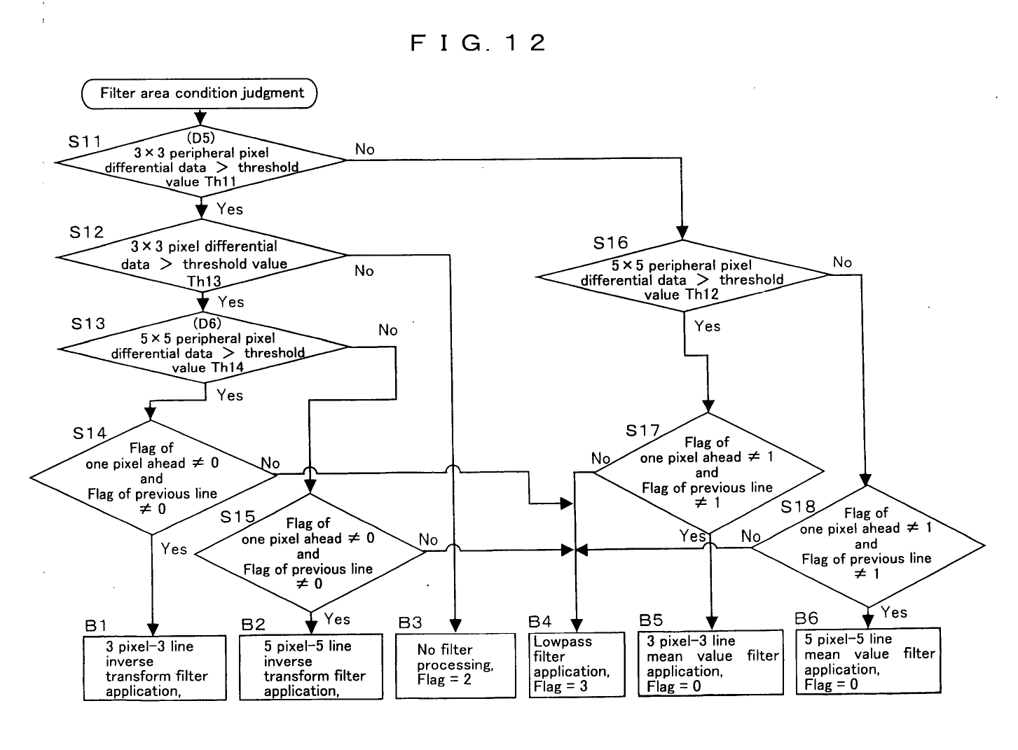

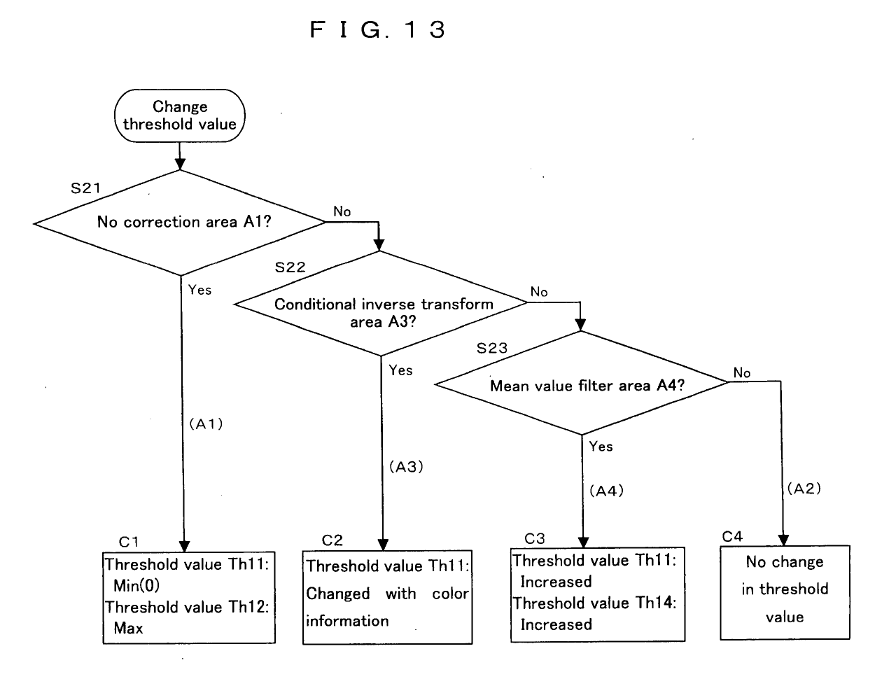

FIG. 12 shows a flowchart of judgment on the filter area conditions performed in the filter condition switching judgment device 23. The filter condition switching judgment device 23 judges which of the following correction filter conditions to apply, based on the data inputted from the filter area information detector 22.
three pixel-in-three line inverse transform filter application B1 for correcting blooming of 3×3 pixels
five pixel-in-five line inverse transform filter application B2 for correcting blooming of 5×5 pixels
no filter processing application B3 where the level of the high frequency is small so that no correction is performed
lowpass filter application B4 that is applied to the boundary between the inverse transform filter and the mean value filter
three pixel-in-three line mean value filter application B5 which performs averaging of 3×3 pixels when there are DC components of 3×3 pixels
five pixel-in-five line mean value filter application B6 which performs averaging of 5×5 pixels when there are DC components of 5×5 pixels

Further, in the filter condition switching judgment device 23, “Flag” is set simultaneously with the setting of the condition. The flag is used for judging the state of the previous pixel. When the mean value filter is applied, it is set as Flag=0. When the inverse transform filter is applied, it is set as Flag=1. When the no filter processing is applied, it is set as Flag=2, and it is set as Flag=3 when the lowpass filter is applied. The flags are used as the adaptive conditions of the lowpass filter.

First, it is judged whether or not condition S11, “3×3 peripheral pixel differential data>threshold value Th11” is satisfied. The threshold value Th11 is a threshold value for judging the noise level, and a small value is set therefore. When the condition S11 is satisfied, it means that there exists some kind of high frequency component. Inversely, when it is not satisfied, it means that there is no high frequency component within the 3×3 pixels. That is, the condition S11 is the diverging point that determines whether to perform the inverse transform filter processing or to perform the mean value filter processing.

Now, description will be given to the case where it is judged to satisfy the condition S11. When judged that the condition S11 is satisfied, it is then judged whether or not condition S12, “3×3 peripheral pixel differential data>threshold value Th13”, is satisfied. The high frequency component level to which the inverse transform is applied is set as the threshold value Th13. When it is judged that the condition S12 is not satisfied, it is considered that the level of the high frequency component in this sample area is small and it is unnecessary to daringly accentuate the high frequency component. Furthermore, this sample area is considered to be the video area that is located between the video area to which the mean value filter is applied and the video area to which the inverse transform filter is applied. Thus, in order to make the boundaries between the both video areas look smooth, this sample area is considered as the video area to which the filter is not applied. Therefore, when the condition S12 is not satisfied, the sample area is recognized as the no filter processing application B3. Based on this recognition, the flag is set as Flag=2 at the same time.

When it is judged that the condition S12 is satisfied, it is then judged whether or not condition S13, “5×5 peripheral pixel differential data>threshold value Th14”, is satisfied. The differences between the current pixel and the adjacent pixels that are the two pixels ahead from the current pixel become the comparative subject with the threshold value Th14. When the blooming is small, the frequency fluctuation becomes large. Thus, the differences between the current pixel and the adjacent pixels that are the two pixels ahead from the current pixel become significant. Inversely, when the blooming is large, the frequency fluctuation becomes moderate. Thus, the differences between the current pixel and the adjacent pixels that are the two pixels ahead from the current pixel become small. This difference is judged based on the threshold value Th14 to determine which of the 3×3 filter or the 5×5 filter is applied.

When it is judged that the condition S13 is satisfied, the sample area is recognized as the three pixel-in-three line inverse transform filter application B1, while it is recognized as the five pixel-in-five line inverse transform filter application B2 when the condition S13 is not satisfied. However, the recognition of the three pixel-in-three line inverse transform filter application B1 at this point is a provisional recognition, and it is judged further in the next step to determine whether or not it is the real recognition.

When the condition S13 is satisfied, it is then judged whether or not condition S14, “the flag of one pixel ahead is not Flag=0, and the flag of one line ahead is not Flag=0”, is satisfied. “Flag=0” is the flag at the time of adapting the mean value filter. Considering the case of the pixel array shown in FIG. 6, the one pixel ahead from the noteworthy pixel “a1” is the pixel a3, and that of the one line ahead from the noteworthy pixel is the pixel a9. When the inverse transform filter processing is performed on the current noteworthy pixel “a1” on a condition that the mean value filter processing is performed on the pixel a3 and the pixel a9 for correcting the filters, the frequency band of the pixel a3 and the pixel a1 become largely different. Thus, the connection between the boundaries does not look smooth. In order to make the boundaries look smooth, it is preferable to change the correction condition to the lowpass filter processing.

Based on such reason, when the condition S14 is not satisfied, this sample area turns to be recognized as the lowpass filter application B4. The flag at this time is Flag=3. When the condition S14 is satisfied, this sample area is formally recognized as the three pixel-in-three line inverse transform filter application B1. The flag at this time is Flag=1.

Now, it will be described returning to the previous condition. When the condition S13 is not satisfied, it is then judged whether or not condition S15, “the flag of one pixel ahead is not Flag=0, and the flag of one line ahead is not Flag=0”, is satisfied. Based on the same reason described above, this sample area is recognized as five pixel-in-five line inverse transform filter application B2 when the condition S15 is satisfied at this time. The flag at this time is Flag=1. In the meantime, when the condition S15 is not satisfied, this sample area is recognized as the lowpass filter application B4. The flag at this time is Flag=3.

Next, description will be given to the case where the condition S11 is not satisfied. When the condition S11 is not satisfied, it is then judged whether or not condition S16, “5×5 peripheral pixel differential data>threshold value Th12”, is satisfied. The threshold value Th12 is a threshold value for judging the noise level, and a small value is set therefore. The condition S16 is a condition for judging whether or not there exists the high frequency component in the adjacent pixels that are the two pixels ahead from the noteworthy pixel. When the condition S16 is satisfied, it means that there is the high frequency component in the two pixels ahead from the noteworthy pixel. In the meantime, when the condition S16 is not satisfied, it means that there are no high frequency components in the adjacent pixels that are the two pixels ahead from the noteworthy pixel. That is, when the condition S11 is not satisfied and at a same time the condition s16 is satisfied, it can be considered that there exists the video having the DC component of 3×3 pixels in this area. In the meantime, when the condition S11 is not satisfied and, at the same time, the condition s16 is not satisfied, it can be considered that there exists the video having the DC component of 5×5 pixels in this area. Based on this point of view, when the condition S16 is satisfied, the sample area is recognized provisionally as the three pixel-in-three line mean value filter application B5. When the condition S16 is not satisfied, the sample area is recognized provisionally as the five pixel-in-five line mean value filter application B6.

When the condition S16 is satisfied, it is then judged whether or not condition S17, “the flag of one pixel ahead is not Flag−1, and the flag of one line ahead is not Flag=1”, is satisfied. The condition of “flag=1” is the flag at the time of adapting the inverse transform filter. Considering the case of the pixel array shown in FIG. 6, the one pixel ahead from the noteworthy pixel “a1” is the pixel “a3”, and that of the one line ahead from the noteworthy pixel “a1” is the pixel a9. When the mean value filter processing is performed on the noteworthy pixel al on a condition that the inverse transform filter processing is performed on the pixel a3 or the pixel a9 for correcting the filters, the frequency band of the pixel a3 and the pixel al become largely different. Thus, the connection between the boundaries does not look smooth. In order to make the boundaries look smooth, it is preferable to change the correction condition to the lowpass filter processing.

Based on such reason, when the condition S17 is not satisfied, this sample area turns to be recognized as the lowpass filter application B4. The flag at this time is Flag=3. When the condition S17 is satisfied, this sample area is formally recognized as the three pixel-in-three line mean value filter application B5. The flag at this time is Flag=0.

Now, it will be described returning to the previous condition. When the condition S16 is not satisfied, it is then judged whether or not condition S18, “the flag of one pixel ahead is not Flag=1, and the flag of one line ahead is not Flag=1”, is satisfied. Based on the same reason as described above, when the condition S18 is satisfied, this sample area is recognized as five pixel-in-five line mean value filter application B6. The flag at this time is Flag=0. In the meantime, when the condition S18 is not satisfied, this sample area is recognized as the lowpass filter application B4. The flag at this time is Flag=3.

Then, in accordance with the judgment results of the four areas A1-A4 described above, the control is performed for changing the threshold values Th11, Th12, Th13, Th14 in the condition for judging the filter area condition.

FIG. 13 shows the flow of this control, referring to the case that it is thought to be the threshold value of the inverse transform as a standard. First, when condition S21, “no correction area A1”, is satisfied, it is considered as a setting C1. In the setting C1, the threshold value Th11 is set to the smallest value, and the threshold value Th12 is set to the largest value. Thereby, the no correction area A1 is fixed to the no filter processing application B3 no matter what kinds of video signals are inputted. When the next condition S22, “conditional inverse transform area A3”, is satisfied, it is considered as a setting C2. For the setting C2, the value of the threshold value Th11 is changed according to the color information. For the current case where the green plants and trees are considered, it is controlled to decrease the threshold value to be lower as the color becomes closer to green. By this control, the inverse transform filter can be readily applied to the colors closer to green, while the mean value filter can be readily applied to other colors. When the next condition S23, “the mean value filter area A4”, is satisfied, it is considered as a setting C3. For the setting C3, the set values of the threshold values Th11 and Th14 are increased. Thereby, the mean value filter can be readily applied to this area. Finally, when judged as being the inverse transform area A2, it is considered as a setting C4. For the setting C4, the setting becomes the standard and there is no change of the threshold value.

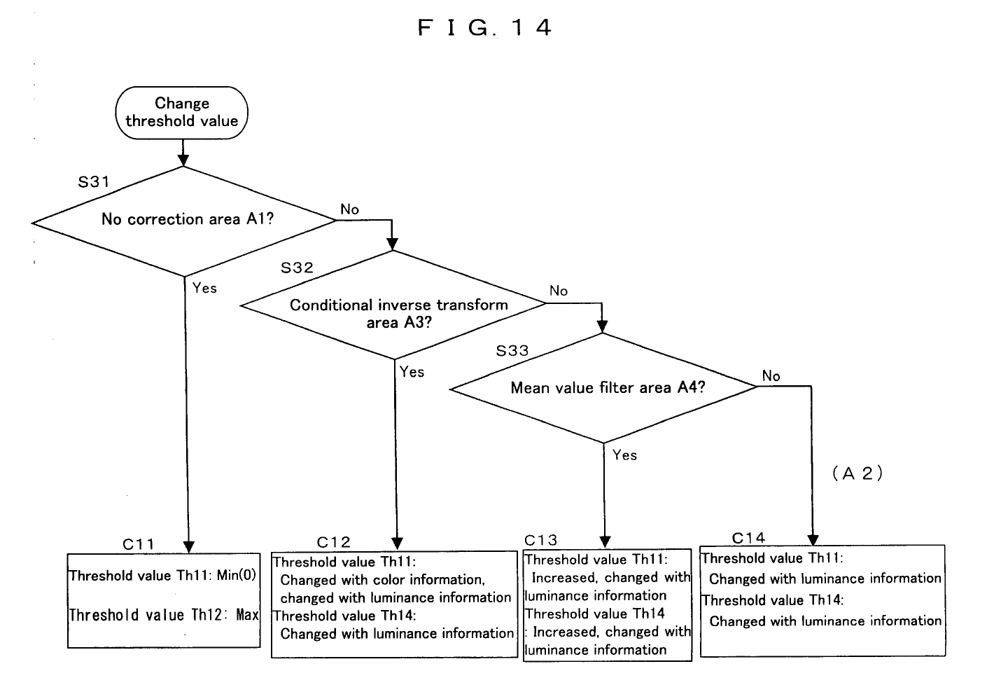

Furthermore, it is possible to add the control through providing additional parameter to the condition. For example, in the case where improvement in the S/N ratio is considered important, the luminance level is added to the parameters. FIG. 14 shows the control flowchart of this case. The conditions of S31, S32, and S33 are the same conditions as S21, S22 and S23 shown in FIG. 13. Normally, the part with the low luminance level in the video signal tends to have bad S/N ratio. Thus, by increasing the threshold values Th11 and Th14 in accordance with the decrease in the luminance level, the S/N ratio in the part particularly in the low luminance can be improved. In the settings C12, C13, and C14, the controls are added for increasing the threshold values Th11 and Th14 as the luminance level decreases.

Further, when the threshold values without any changes are used for all in the areas, the threshold values in the boundaries of the sample areas fluctuate drastically. Thus, the boundaries between the sample areas are not connected smoothly. Therefore, fluctuating parts of several tens of pixels are provided mutually, and the threshold values of the adjacent areas are multiplied by the coefficients to change the threshold values gradually. For example, it is assumed in the structure of FIG. 11 that the sample area G4 is recognized as the mean value filter area, and the sample area G5 is judged as the inverse transform area. In this case, when it is assumed that the threshold value Th11 of the mean value filter area G4 is “50”, the threshold value Th11 of the inverse transform area G5 is “10”, and the fluctuating parts have ten pixels, the threshold values fluctuate as in 50, 46, 42, 38, 34, 30, 26, 22, 18, 14, 10 considering from the mean value area G4. In this case, the change amount of the threshold value per pixel is set as “4” based on the calculation result of the threshold value change amount, (50−10)/10=4. Based on this, the threshold values can be shifted gradually.

As described above, the switching condition of the selector 25 is determined according to the selection control signal generated by the filter condition switching judgment device 23 to perform control of the selector 25, and the filter coefficient of the filter coefficient register 24 is selected. Then, the selected filter coefficient is inputted to the filter processor 26 to execute the filter processing so as to thereby achieve a control to change the adapted filter.

Regarding the improvement in the S/N ratio, it has been described to change the threshold value in accordance with the luminance level. It may also be achieved by changing the extent of the filter. For changing the extent of the filter, the filter coefficient of the noteworthy pixel “a1” in the filter array of FIG. 6 may be altered. When the filter coefficient of the noteworthy pixel a1 is increased, the ratio of the noteworthy pixel with respect to the peripheral coefficients becomes large. Thus, the extent of the filter applied thereupon becomes smaller. Inversely, the extent of the filter applied thereupon becomes larger when the filter coefficient of the noteworthy pixel a1 is made smaller. Like this, the filter coefficient of the noteworthy pixel may be altered in accordance with the luminance level.

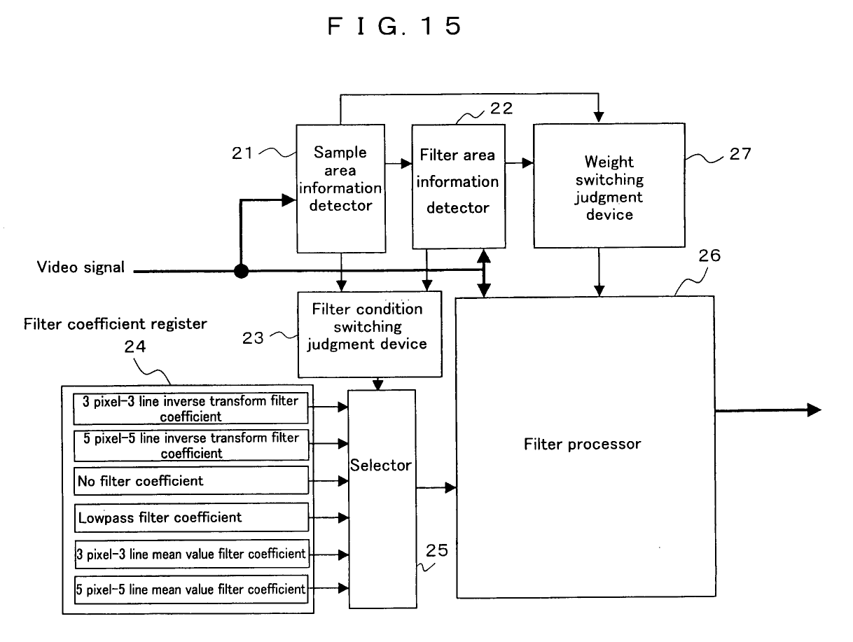

FIG. 15 shows the structure of the adaptive filter to which this control is added. In this structure, a weight switching judgment device 27 is provided further to the adaptive filter shown in FIG. 3. The luminance level signals are inputted to the weight switching judgment device 27 from the sample area information detector 21 and the filter area information detector 22. The weight switching judgment device 27 generates the correction coefficient of the filter coefficient for the noteworthy pixel in accordance with the inputted luminance signal level, and supplies it to the filter processor 26. When performing the filter processing, the filter processor 26 performs correction by multiplying the supplied correction coefficient to the filter coefficient of noteworthy pixel, and performs the filter processing based on the corrected filter coefficient. At this time, the weight switching judgment device 27 sets the correction coefficient to be small when the luminance level at the time of adapting the inverse transform filter is low, and sets it to be large when the luminance level is high. Similarly, when the luminance level at the time of adapting the mean value filter is low, the correction coefficient is set to be small, and it is set to be large when the luminance level is high.

In the above, it has been described referring to the case where the sample area is divided into twelve areas. However, the sample area generally is the area divided into m×n areas, and the accuracy of the control can be enhanced as the larger numbers of areas is increased. Moreover, the filter area has been described here referring to the case of 5×5 filter areas, however, the same can be achieved in arbitrary m×n filter areas.

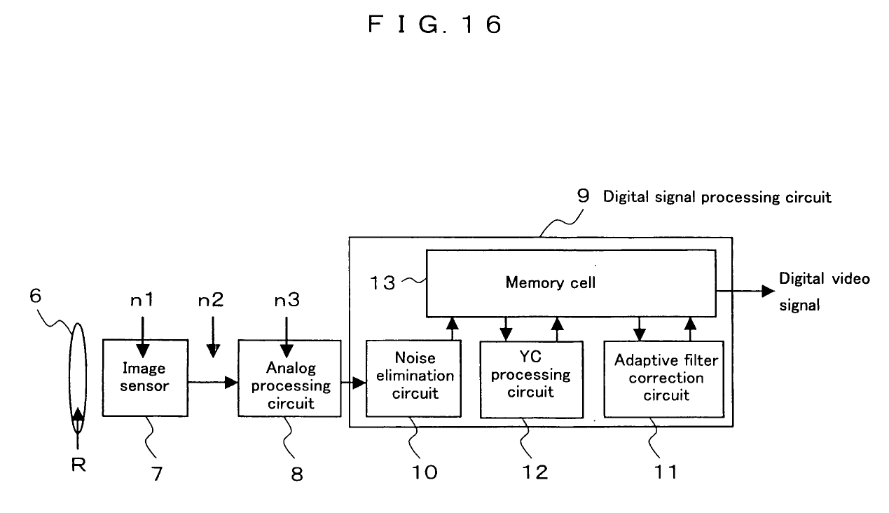

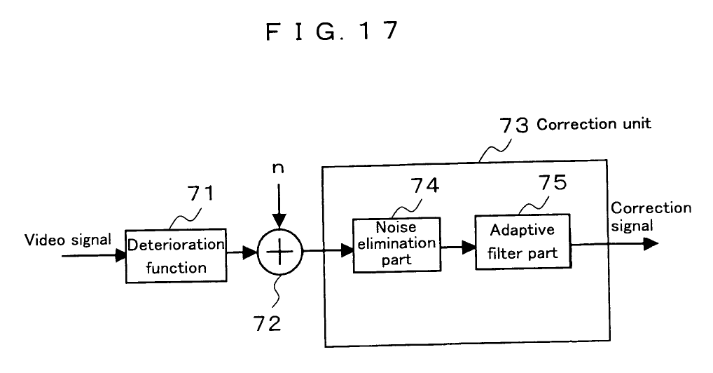

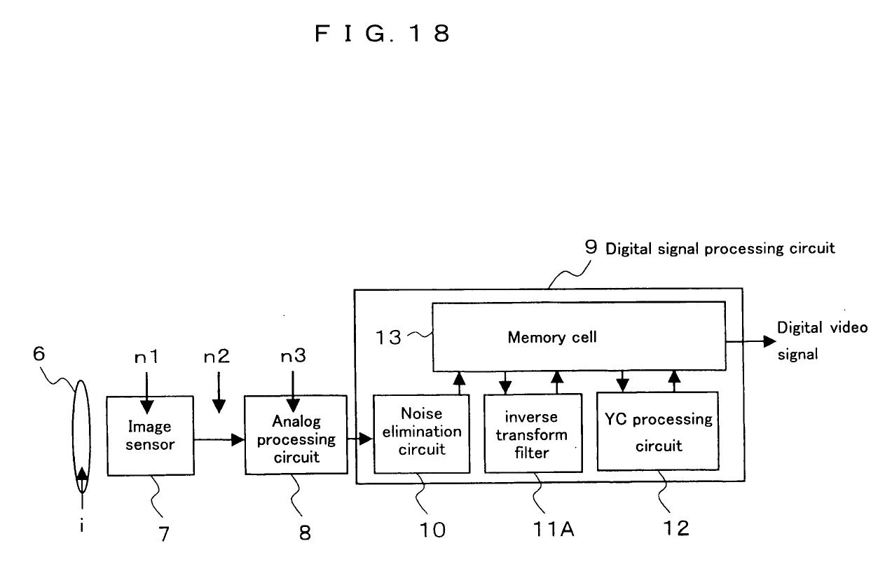

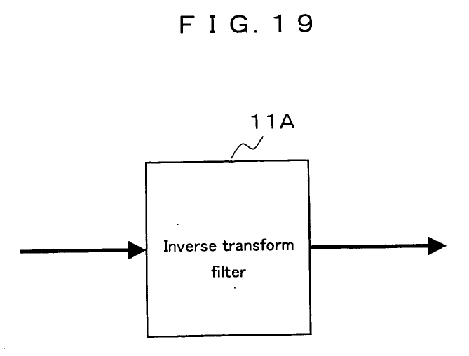

Regarding where to adapt this filter, it is possible to perform the processing in real time when it is carried out before the YC processing by the YC processing circuit 12, as described in FIG. 2. It is desirable to perform the filter processing by each of the colors R, G, B when the filter is adapted in the Bayer array. Each data of R, G, and B is present at every other pixel. Thus, an absent pixel is generated from the peripheral pixel by multiplying the coefficient. Extraction and the like of the frequency band and the fluctuation level are performed on each of R, G, B, and all the data of R, G and B are referred to only for the condition of the color signal level. In the case where it is adapted to Y, Cr, and Cb, extraction and the like of the frequency band and the fluctuation level are performed with Y signal, and the condition of the color signal level is judged with Cr and Cb. For the filter adaptation, it is adapted to the Y signal. As the high frequency is not required for Cr, Cb, it is desirable to change the threshold value and apply it to only the mean value filter as the structure. In the case where it is adapted to Y, Cr, and Cb, it is possible to be adapted after the YC processing as shown in FIG. 16. In this case, the image is recorded to the memory cell 1 after the YC processing by the YC processing circuit 12 3. The adaptive filter correction circuit 11 performs the processing by reading out again the once-recorded video signal. The video of YC-processed data recorded can be checked visually by retrieving it to the outside. Thus, it becomes possible to switch the changing condition of the adaptive filter correction circuit 11 by each video while viewing it. Further, it is possible to adapt it as the filter for customizing as the after-treatment of the YC processing, although it cannot be performed in real time. For example, when the image with blooming over the entire image is stored, the setting is changed to the condition with which the inverse transform filter can be readily applied. Specifically, the threshold value Th2 of FIG. 10 may be set larger and the threshold value Th3 is set smaller. Furthermore, when the image that is filmed at a dark place with the bad S/N ratio is recorded, the setting is changed to the condition with which the mean value filter can be readily applied. Specifically, the threshold value Th2 of FIG. 10 may be set larger, the threshold value Th3 as larger, the threshold value Th11 of FIG. 15 as larger, and the threshold value Th14 as larger. By keeping a state to record some of those conditions in advance as the changing parameters, it is possible to perform correction easily through the menu setting of the camera.

The present invention has been described in detail referring to the most preferred embodiments. However, various combinations and modifications of the components are possible without departing from the spirit and the broad scope of the appended claims.

What is claimed is:

1. A filter correction circuit for a camera system, comprising:
a sample area information detector for detecting frequency band and fluctuation level of a video signal by a unit of sample area in a single screen that is divided into a plurality of areas;
a filter area information detector for detecting said frequency band and fluctuation level of said video signal by a unit of filter area that becomes a subject for one-time filter processing in said single screen;
a filter condition switching judgment device for judging which of filter conditions each sample area corresponds to, based on a result detected by said sample area information detector, judging a filter type to be applied to a pixel unit or a smallest pixel group unit based on a result detected by said filter area information detector, and generating a selection control signal indicating a filter coefficient that corresponds to said filter condition and said filter type which have been judged;
a filter coefficient register to which a plurality of kinds of filter coefficients having different properties from each other are stored;
a selector for selecting a filter coefficient to be applied from said plurality of kinds of filter coefficients in said filter coefficient register based on said selection control signal generated by said filter condition switching judgment device; and
a filter processor which fetches said filter coefficient selected by said selector from said filter coefficient register, and applies it to said pixel unit or smallest pixel group unit which correspond to said filter coefficient.

2. The filter correction circuit according to claim 1, wherein said sample area is set in a size with which subject image features on a single screen can be sectioned.

3. The filter correction circuit according to claim 1, wherein said sample area is set larger than said filter area.

4. The filter correction circuit according to claim 1, wherein:
said filter coefficient register stores a plurality of kinds of inverse transform filter coefficients having different properties from each other, as said plurality of kinds of filter coefficients, and
said filter condition switching judgment device judges which of said plurality of kinds of inverse transform filter coefficients to apply based on said frequency band detected by said sample area information detector and said frequency band detected by said filter area information detector.

5. The filter correction circuit according to claim 1, wherein:
said filter coefficient register stores an inversion filter coefficient and a mean value filter coefficient, as said plurality of kinds of filter coefficients, and
said filter condition switching judgment device judges which of said inverse transform filter coefficient or said mean value filter coefficient is applied based on said fluctuation level detected by said sample area information detector and said fluctuation level detected by said filter area information detector.

6. The filter correction circuit according to claim 5, wherein:
said filter coefficient register stores said inverse transform filter coefficient, said mean value filter coefficient and a lowpass filter coefficient, as said plurality of kinds of filter coefficients, and
said filter condition switching judgment device applies said lowpass filter coefficient to a boundary at which application of said inverse transform filter coefficient is switched to application of said mean value filter coefficient, or to a boundary at which application of said mean value filter coefficient is switched to said inverse transform filter coefficient.

7. The filter correction circuit according to claim 5, wherein:
said filter coefficient register contains said inverse transform filter coefficient and a plurality of kinds of filter coefficients having different properties from each other, as said plurality of kinds of filter coefficients, and
when applying said mean value filter coefficient, said filter condition switching judgment device judges which of said plurality of kinds of mean value filter coefficients is applied in accordance with size of an area considered as having a small fluctuation level that is detected by said sample area information detector.

8. The filter correction circuit according to claim 5, wherein:
said sample area information detector further detects color information of said sample area;
said filter area information detector further detects color information of said filter area; and
said filter condition switching judgment device determines which of said inversion filter coefficient or said mean value filter coefficient is applied in accordance with at least either of said color information of said sample area detected by said sample area information detector or alignment information of said sample area, and said color information of said filter area detected by said filter information detector.

9. The filter correction circuit according to claim 1, wherein:
said sample area information detector further detects luminance level and color level of said sample area,
said filter area information detector further detects luminance level and color level of said filter area, and
said filter condition switching judgment device changes correction level by changing a center coefficient of said filter coefficients-based on at least either of said luminance level or said color level detected by at least either of said sample area information detector or said filter area information detector.

10. The filter correction circuit according to claim 1, which performs correction in real time through carrying out filter processing with said filter processor by a unit of R, G, and B in a state of Bayer array before performing YC processing.

11. The filter correction circuit according to claim 1, which performs filter processing with said filter processor on Y, Cr, Cb after YC-processing so as to change a filter switching condition in accordance with an image.

12. The filter correction circuit according to claim 1, further comprising a CPU for controlling said filter correction circuit, wherein
filter switching accuracy is increased by fetching information detected by said sample area information detector into said CPU.

13. The filter correction circuit according to claim 1, further comprising other wave-detector, wherein
said sample area information detector is used together with said other wave-detector.
